(19) United States
(12) Patent Application Publication
(10) Pub. No.: US 2007/0011100 A1
(43) Pub. Date: Jan. 11, 2007

(54) Preventing identity theft

(76) Inventors: Phil Libin, Cambridge, MA (US); David Engberg, Washington, DC (US)

Correspondence Address: MUIRHEAD AND SATURNELLI, LLC, 200 FRIBERG PARKWAY, SUITE 1001, WESTBOROUGH, MA, 01581, US

(21) Appl. No.: 11/471,273

(22) Filed: Jun. 20, 2006

Related U.S. Application Data
(60) Provisional application No. 60/692,634, filed on Jun. 21, 2005.

(51) Int. Cl. G06Q 99/00

(52) U.S. Cl. 705/65

(57) ABSTRACT

Determining whether to remotely authorize an action on behalf of a requester includes having the requester provide a privacy token, remotely obtaining data from the privacy token, and authorizing the action if the data from the privacy token verifies that the requester is authorized to take the action. The action may include issuing a credit card for the requester. The privacy token may be a smart card. The data may be digitally signed. Determining whether to remotely authorize an action on behalf of a requester may also include authorizing the action if the requester had previously indicated a desire not to require presentation of the privacy token. The action may be authorized only if the data from the privacy token verifies the identity of the requester.

### CROSS-REFERENCE TO RELATED APPLICATIONS

This application claims priority to U.S. provisional patent application 60/692,634 filed on Jun. 21, 2005, which is incorporated by reference herein.

### BACKGROUND OF THE INVENTION

1. Technical Field

This application relates to security, and more particularly to preventing identity theft using information security techniques that help verify the identity of a person in possession of information needed to obtain credit or perform some other task on behalf of that person.

2. Description of Related Art

Identity theft encompasses a class of crimes in which a criminal obtains personal/financial information about a victim which the criminal then uses to obtain goods and/or services in the name of the victim. Of course, the criminal has no intent to pay for the goods and/or services. In many cases, the criminal uses the victim's personal/financial information to open one or more credit card accounts. The criminal uses the fraudulent credit cards to purchase as many goods and/or services as possible before the fraud is discovered.

Although in many cases the victim may be protected from significant liability by statue and/or credit card company policies that limit the liability of the victim in such situations, the merchants who have provided the goods and/or services to the criminals are left to bear the cost of the fraud. The merchants pass this cost on to legitimate consumers in the form of higher prices. In addition, even though the victim may escape direct financial liability, it is often the case that the victim's credit rating may suffer. Of course, if the identity theft occurred through no fault of the victim, then, in the end, the victim should have a full opportunity to straighten out his or her credit rating. However, it is not uncommon for it to take two or three years to do this, during which time the victim may have difficulty getting credit. In addition, it is often a significant amount of effort for a victim to contact all of the credit bureaus and other interested parties in order to straighten out his credit rating after being the victim of identity theft.

One solution would be to make the requirements for obtaining credit cards and the like more stringent. For example, it may be possible to issue credit cards only on the condition that an applicant present himself or herself in person with appropriate credentials, such as a U.S. passport. However, making the credit card application process more onerous would probably work to the detriment of potential applicants as well as to that of credit card issuers and merchants. In addition, even with making in the application process more difficult, potential criminals may still find ways to circumvent the more stringent requirements.

It would be useful to provide a technique that could help ensure that someone providing personal/financial information for a particular individual to obtain a credit card or the like is in fact that particular individual.

### SUMMARY OF THE INVENTION

According to the present invention, determining whether to remotely authorize an action on behalf of a requester includes having the requester provide a privacy token, remotely obtaining data from the privacy token, and authorizing the action if the data from the privacy token verifies that the requester is authorized to take the action. The action may include issuing a credit card for the requester. The privacy token may be a smart card. The data may be digitally signed. Determining whether to remotely authorize an action on behalf of a requester may also include authorizing the action if the requester had previously indicated a desire not to require presentation of the privacy token. The action may be authorized only if the data from the privacy token verifies that the requester is authorized to take the action. The data provided in the privacy token may be encrypted to inhibit directly ascertaining identifying information about the requester. The data may be encrypted using a one-way hash function. Determining whether to remotely authorize an action on behalf of a requester may include applying the one-way hash function to identifying information about the requester and comparing the result thereof with the data provided in the privacy token. The requester may provide the privacy token in response to obtaining a particular credit score for the requester. A computer readable medium having computer executable instructions may be provided for performing any of the foregoing steps.

According further to the present invention, a privacy token includes an electronic identifier that stores data, a data communicator coupled to the electronic identifier, and data, provided on the electronic identifier, that binds the privacy token to a holder thereof, where the data is authenticated by an authority that is trusted by a provider of service to the holder. The data may be digitally signed by the authority. The data provided in the privacy token may be encrypted using a one-way hash function to inhibit directly ascertaining identifying information about the requester.

According further to the present invention, administering privacy tokens that have data that binds each of the privacy tokens to a holder thereof using authenticated data includes receiving, from a token issuing authority, authenticated information indicating that a particular privacy token has been issued and providing a transaction authority with authenticated information indicating that the particular privacy token has been issued by the token issuing authority, wherein the transaction authority authorizes use of the privacy token in response to receiving the second authenticated information. The authenticated information received from the token issuing authority may be different from the authenticated information provided to the transaction authority or may be the same. An authority granting agency may communicate information indicating particular token issuing privileges of the token issuing authority. The authenticated information provided to the transaction authority may depend, at least in part, on information provided by the authority granting agency. A computer readable medium having computer executable instructions may be provided for performing any of the foregoing steps.

### BRIEF DESCRIPTION OF DRAWINGS

FIG. 1 illustrates a privacy token that may be used with the system described herein.

FIG. 2 is a diagram illustrating a holder of a privacy token, a network, and a credit card issuer according to the system described herein.

FIG. 3 is a flow chart illustrating a credit card issuer determining whether to provide a credit card to a requester according to the system described herein.

FIG. 4 is a diagram illustrating an issuing authority, a transaction authority, and a clearinghouse according to the system described herein.

### DETAILED DESCRIPTION OF VARIOUS EMBODIMENTS

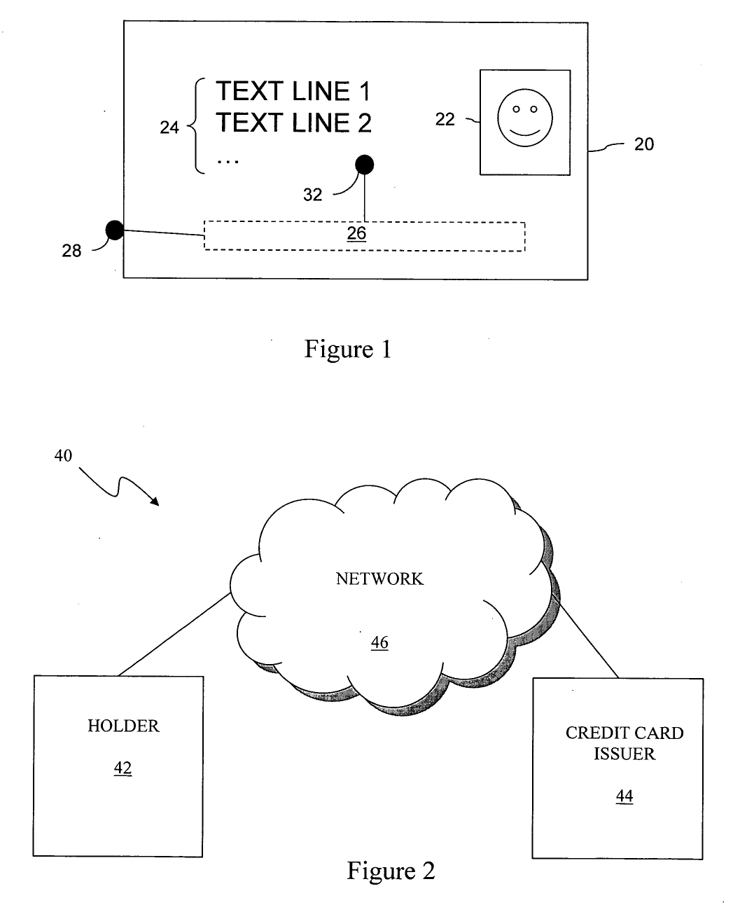

Referring to FIG. 1, a privacy token 20 is provided in the form of a plastic card having printed thereon a photograph 22 of the holder and written information 24 such as the holder's name and possibly other identifying information. The privacy token 20 may also contain at least one electronic identifier 26, such as a magnetic strip like that used with credit cards, an embedded microprocessor like that used with smart cards, or some other appropriate component for providing the functionality described herein. In an embodiment herein, the privacy token 20 is a smart card and the electronic identifier is an embedded microprocessor.

The electronic identifier 26 may be coupled to a data communicator, such as an electrical contact 28, for transmitting data signals to the electronic identifier 26 and receiving data signals from the electronic identifier 26. Of course, any other appropriate data communicator may be used to communicate data signals with the electronic identifier 26. For example, a radio frequency (or other frequency) transmitter and receiver 32 may be used.

The electronic identifier 26 may contain information that binds the holder of the smartcard 20 with a particular identity. For example, the electronic identifier 26 may simply contain the information: “The holder of this card is John Smith”. In some cases, the information may be digitally signed (by, for example, a trusted authority) or otherwise authenticated in a way that would be difficult, if not impossible, for a malicious user to forge. In some embodiments, the smartcard may contain data validated using systems provided by CoreStreet, Ltd of Cambridge, Mass. and/or techniques described in one or more of the following issued patents/published applications: U.S. Pat. Nos. 5,420,927; 5,604,804; 5,610,982; 5,666,416; 5,717,757; 5,717,758; 5,717,759; 5,793,868; 5,960,083; 6,097,811; 6,292,893; 6,301,659; 6,487,658; 6,766,450; US20020165824; US20040049675; US20040237031; US20050010783; US20050055567; US20050044386; US20050033962; US20050044376; US20050044402; US20020046337; and US20020165824.

In an embodiment herein, the photograph 22 and the written information 24 would be optional but still useful for identifying the holder of the privacy token 20. As described in more detail elsewhere herein, the identity security may rely upon the information stored in the electronic identifier 26, especially in instances where the photograph 22 and/or written information 24 may be forged by a malicious user. However, the photograph 22 and/or written information may be used, for example, to prevent the holder from mixing up his or her card with that of another holder. The photograph 22 and/or the written information 24 may also be used to assist in returning a lost privacy token 20 to the holder thereof. In addition, as explained in more detail elsewhere herein, in some embodiments, the written information 24 may include the result of one-way hashing (or applying a similar function) to some or all of the data stored by the electronic identifier 26.

Note that although it is possible for the privacy token 20 to contain or have printed thereon information that identifies the holder, it is not necessary. In some cases, it is sufficient that the privacy token 20 contains information uniquely bound to the privacy token 20. In such a case, other information may exist somewhere else that binds the holder with the privacy token 20. For example, the privacy token 20 may contain only a unique serial number that is digitally signed by a trusted authority while the holder possesses a separate digital certificate that binds the holder with the particular serial number. In such a case, the combination of the privacy token 20 and the digital certificate may bind the holder to the privacy token 20 even though the privacy token 20, by itself, can not be used to the identify of the holder.

The system described herein may be implemented with a device other than a smartcard, such as a memory stick or other device capable of holding computer generated information. Accordingly, for the discussion that follows, the term “smartcard” should be understood to include actual smartcards as well as any other appropriate mechanism for providing the functionality described herein.

Referring to FIG. 2, a diagram 40 illustrates a holder 42 of the privacy token 20 in communication with a credit card issuer 44 via a data network 46 such as the Internet. Of course, the holder 42 and the credit card issuer 44 may communicate by any appropriate means other than the data network 46, such as a direct data connection, by telephone, by being physically in the same location (e.g., the holder 42 visits the credit card issuer 44), etc.

The holder 42 may contact the credit card issuer 44 to have the credit card issuer 44 place the holder 42 on a list that prevents the holder 42 from obtaining a new credit card or the like unless the holder 42 can prove that he or she is in physical possession of the privacy token 20. In some embodiments, a clearing house or similar service provider may be contacted by the holder 42 and, as a result, the clearing house or similar service provider causes the holder 42 to be placed on the list for one or more credit card issuers and/or one or more issuers of other types of credit. In some embodiments, all new potential credit recipients are placed on the list by some credit card issuers and/or issuers of other types of credit. In some instances, the holder 42 needs to take positive steps to be taken off the list.

Having the holder 42 (and other holders) on such a list deter identity theft that occurs when criminals “hack” into a commercial computer system or the like to obtain personal/financial information about holders that could otherwise be used to fraudulently obtain credit cards and/or other types of credit in the names of the holders. A criminal would not be able to fraudulently obtain a credit card or other type of credit in the name of a holder in cases where proof of physical possession of the privacy token 20 is required to obtain a new credit card and/or other type of credit.

Note that all a holder need do is prove possession of the privacy token 20, irrespective of whether the privacy token 20 contains specific information that identifies the holder. As long as the privacy token 20 can be uniquely identified, the credit card issuer 44 need only ask for the privacy token 20 for the system to work. For example, the holder 42 may request that the credit card issuer 44 (and other like issuers) issue no credit cards unless the requester identifying himself or herself as the holder 42 presents a privacy token 20 having a specific serial number or being otherwise uniquely identified. In such a case, the privacy token 20 does not contain any information identifying the holder 42, but the holder 42 is still protected from identity theft since only the holder 42 can present the privacy token 20. Thus, the privacy token 20 may be “blank” in the sense that the privacy token 20 does not contain specific information that could be used to identify the holder 42. Of course, it is also possible to provide the identity token 20 in a form that specifically identifies the holder 42.

In some instances, the holder 42 may desire to use the system described herein to restrict other types of transactions. For example, the holder 42 may have himself or herself placed on a list that requires proof of physical possession of the privacy token 20 for transactions over a certain dollar amount. In that way, the holder 42 is not burdened with having to always maintain possession of the privacy token 20 for relatively small transactions while still being protected from identity theft in connection with relatively large transactions. Other types of transactions to which the system may be used include applying for a loan, transfer of funds. For some embodiments, the holder 42 may be able to specify the kinds of transactions and amounts (e.g., any new account requests and/or funds transfers over $5,000). Accordingly, the system described herein may be extended to any service or a transaction where the service provider or transaction participant agrees not to provide the service or perform the transaction with a holder unless the holder can provide proof of physical possession of the privacy token 20. Thus, for the discussion herein, the term “credit card issuer” (and related terms) may be understood to include any service provider or transacting party that provides service to a user or transacts with the holder 42 according to the system described herein.

Proof of physical possession may be provided in any number of ways. For example, the holder 42 may have a smartcard reader (not shown) coupled to the data network 46 or through the holder's personal computer or by some other appropriate means. The smartcard reader may then read the validated information from the privacy token 20 and provide that information, along with possibly other information, to the credit card issuer 44. The other information may include, for example, time and date information and/or possibly a pin number provided by the holder 42. In other instances, there may be a mechanism for providing biometric information of the holder 42 that may be compared with information stored on the privacy token 20, information stored by the credit card issuer 44, or possibly both. In some embodiments, the holder 42 may be required to present the card to an authorized representative, such as a bank officer.

Of course, the holder 42 may take steps to inhibit theft of the privacy token 20 such as placing the privacy token 20 in a safe deposit box. Such steps would be appropriate since the privacy token 20 may not be needed for everyday transactions.

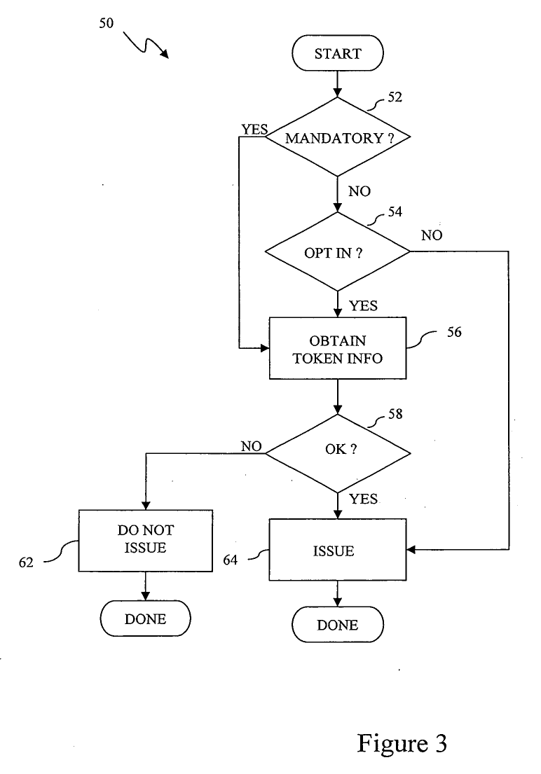

Referring to FIG. 3, a flow chart 50 illustrates steps performed by the credit card issuer 44 (or other type of service/transaction provider) in connection with determining whether to issue a credit card to the holder 42 (or provide some other type of service/transaction). Processing begins at a first step 52 where it is determined if the system is mandatory for all potential recipients of credit cards. As discussed elsewhere herein, in some instances, it is possible to make the system described herein mandatory so that no credit cards are issued unless the potential recipient can prove that he or she possesses the privacy token 20. In other instances, a potential credit card recipient may opt in to the system or not.

If it is determined at the test step 52 that the system is not mandatory, then control transfers from the test step 52 to a test step 54 where it is determined if the potential credit card recipient has opted in to the system. If so, then control transfers from the step 54 to a step 56 where information is obtained from the privacy token 20 (e.g., from the electronic identifier 26). As discussed elsewhere herein, the information may be obtained in any appropriate fashion, such as using a smartcard reader coupled to the Internet. Note that the step 56 is also reached if it is determined at the step 52 that the system is mandatory.

Following the step 56 is a test step 58 where it is determined if the information obtained from the privacy token 20 indicates that it is OK to issue a credit card. In an embodiment herein, the information obtained from the privacy token 20 is data identifying the holder that has been digitally signed by an authority that is trusted by the credit card issuer. However, any other appropriate mechanism may be used.

If it is determined at the test step 58 that it is not OK to issue a credit card, then control transfers from the step 58 to a step 62 where appropriate steps are taken to prevent the issuance of a credit card and/or a message is provided to the requester. It is also possible at the step 62 to alert the authorities that someone may be attempting to fraudulently obtain a credit card. Following the step 62, processing is complete.

If it is determined at the step 58 that it is OK to issue a credit card, then control transfers from the step 58 to a step 64 where appropriate steps are taken to cause the credit card to be issued to the requester. Note that the step 64 may also be reached if it is determined at the step 54 that the requester has not opted in to the system. Following the step 64, processing is complete.

In some embodiments, a mechanism similar to that described in U.S. Pat. No. 5,666,416 may be used to protect against the possibility of a crimial stealing the privacy token 20. In those cases, a new authorization code may be provided by an authority on a periodic basis to the privacy token 20. If the user reports that the privacy token 20 has been stolen, the authority that issues the new authorization codes stops issuing codes for the privacy token. Note that such a system may even be implemented by having a user memorize or have written down appropriate information (e.g., validation information) since the added condition of an authority issuing a periodic authorization code may reduce or eliminate the requirement that a user be in physical possession of a privacy token.

In some embodiments, the privacy token 20 may be configured so as not to contain any personal or identifying information of the holder 42 that would be directly accessible. For example, prior to storing the identity information on the privacy token 20, the information may be one-way hashed so that readers of the information may not directly ascertain any personal identity information about the holder 42. In this way, even the identity of the holder 42 may be protected. The credit card issuer 44 could still verify the holder 42 by applying the same one-way hash function to the information stored by the credit card issuer 42 and comparing the result thereof to the information stored on the privacy token 20.

As an added protection of the identity of the holder 42 (and possibly added security), the credit card issuer 44 may not store information directly identifying the holder 42. Instead, the credit card issuer 44 may store, for example, a one-way hash of the social security number of the holder 42. If the holder 42 never requests a credit card from the credit card issuer 44, the credit card issuer 44 will not have information that could be used to directly identifying the holder 42. However, in such a case, when the holder 42 requests a new credit card from the credit card issuer 44, the credit card issuer 44 may perform the one-way hash function on the social security number of the holder 42 (provided by the holder 42 in connection with the application) and compare the result thereof to the database of participants in the system. Of course, other types of information may be used in lieu of a social security number. For example, it may be possible to one-way hash the name of the holder 42.

In some embodiments, it may be possible to provide as part of the written information 24 the one-way hash of the information stored in the electronic identifier 26. This could provide added security as well as a relatively quick way to detect tampering with the data stored in the electronic identifier 26. In other embodiments, the written information 24 may be part of a pin/key that is used with information stored in the electronic identifier 26. Thus, even if it were possible for a malicious user to electronically read information from the privacy token 20 without the knowledge or permission of the holder 42, the information obtained from the electronic identifier 26 may be rendered useless without also having the written information 24 which may only be obtained visually. In such a case, the malicious user may gain nothing of practical value from electronically reading a card that remains in the pocket/wallet of the holder 42.

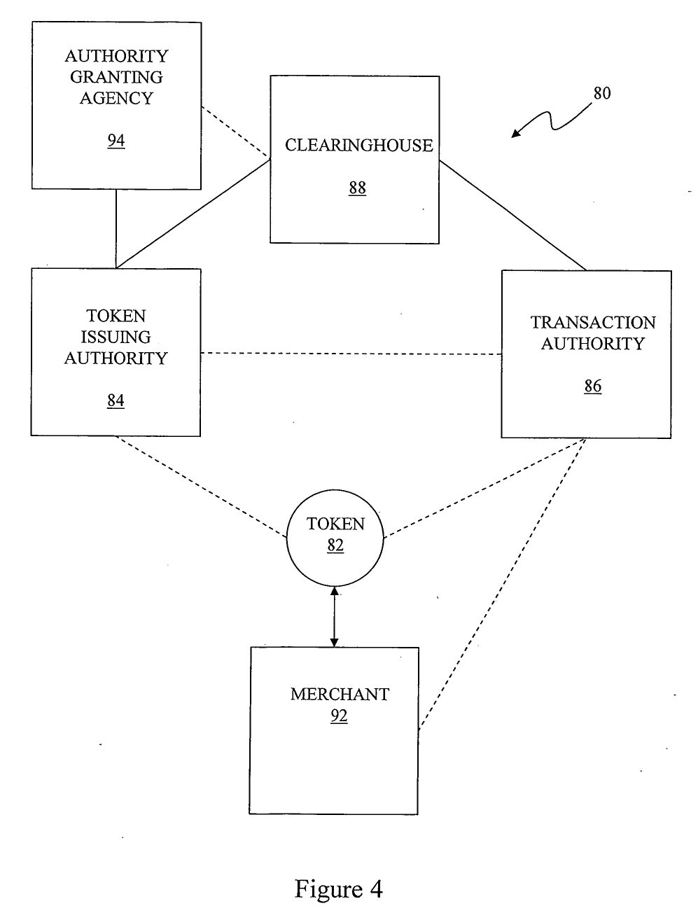

Referring to FIG. 4, a diagram shows a privacy token 82 that is issued by a token issuing authority 84. The token issuing authority 84 may be any competent authority capable of providing the privacy token 20 with data that can not be easily forged or duplicated. Also shown is a transaction authority 86, which verifies the privacy token 82 in connection with transactions involving the privacy token 20. In some embodiments, the token issuing authority 84 and the transaction authority 86 may be the same entity or related entities. In other embodiments, the token issuing authority 84 is independent of the transaction authority 86.

In instances where the token issuing authority 84 is independent of the transaction authority 86, a clearinghouse 88 may be used to exchange authenticated information between the token issuing authority 84 and the transaction authority 86 so that the transaction authority 86 properly recognizes the privacy token 82. For example, when the token issuing authority 84 issues the privacy token 82, the token issuing authority 84 may send authenticated information (e.g., a digitally signed string) to the clearinghouse 88 identifying the privacy token 82, the holder, and possibly other information, such as the holder's initial choice of which transactions, transaction amounts, etc. require presentation of the privacy token 82. The clearinghouse 88 could then verify the information (e.g., by checking the digital signature, ensuring that the issuer is a recognized authority and has not been compromised, etc.). If the clearinghouse 88 is satisfied with the authenticated information from the token issuing authority 84, the clearinghouse 88 could then either pass the authenticated information on to the transaction authority 86 or the clearinghouse 88 could generate new authenticated information to provide to the transaction authority 86 (e.g., a digitally signed string) identifying the privacy token 82, the holder, possible additional information, etc. Note that it is not necessary for the transaction authority 86 to know or trust the token issuing authority 84 since it is sufficient that the transaction authority 86 trusts the authenticated information provided by the clearinghouse 88.

In an embodiment herein, the holder presents the privacy token 82 to a merchant 92. The merchant 92 represents a conventional merchant, a credit card issuer, a bank, and/or any other entity that can provide a service or facilitate a transaction for the holder of the privacy token 82. The merchant 92 could contact the transaction authority 86 for verification of the privacy token 82. In some instances, the transaction authority 86 may already possess sufficient information for verifying the privacy token 82. For example, the transaction authority 86 may have cached previous information or may be related to (or may be) the token issuing authority 84. In instances where the transaction authority 86 does not already posses sufficient information to verify the privacy token 82, the transaction authority 86 may contact the token issuing authority 84 either directly or through the clearinghouse 88. In some instances, the merchant 92 may also act as the transaction authority 86.

In some embodiments, it is possible to also have an optional authority granting agency 94, which grants the issuing authority 84 (and possibly other issuing authorities) the right to issue privacy tokens. The right may be granted unconditionally (i.e., the issuing authority 84 can issue privacy tokens of any type to anyone) or the right may be conditional based on any combination of factors. For example, if the authority granting agency 94 is a bank and the issuing authority 84 is a university or social group, then the issuing authority 84 may be restricted to issuing privacy tokens to university students or members of the social group. Any other type of restriction is also possible, including a restriction on the transaction limit or type for which the privacy tokens may be used, restrictions on the number of privacy tokens that may be issued in a given period, etc. In some embodiments, the authority granting agency 94 may provide information to the clearinghouse 88 indicating that particular token issuing privileges have been granted to the token issuing authority 84. The clearinghouse 88 may use the information provided by the authority granting agency 94 in connection with verifying information from the token issuing authority 84.

Note that the system described herein is an opt-in system that does not require a minimum number of users to work. Thus, the credit card issuer 44 (or other service provider/transacting party) may provide the system described herein as an option for any potential user. Of course, it is also possible to make the system described herein mandatory so that the credit card issuer 44 (or other service provider/transacting party) requires users to provide proof of physical possession of the privacy token 20. In some embodiments, it may be useful to require the user to enter a pin, provide biometric information, or require something similar in order to access/use the privacy token 20. This could prevent the privacy token 20 from being used without the holder's consent and could prevent the privacy token 20 from being used to track a holder's identity of movements.

It is possible to integrate the system described herein with the existing credit score infrastructure. For example, a bank or other institution may perform a credit check on the holder and receive, in response thereto, an indicator that a privacy token is required to perform the requested transaction. For example, the credit agency could return a credit score of −1 or some other number that is not a possible credit score. In other embodiments, it is possible to adopt a policy whereby a conventional credit score below a predetermined amount triggers the requirement to present the token.

While the invention has been disclosed in connection with various embodiments, modifications thereon will be readily apparent to those skilled in the art. Accordingly, the spirit and scope of the invention is set forth in the following claims.

What is claimed is:

1. A method of determining whether to remotely authorize an action on behalf of a requester, comprising:
having the requester provide a privacy token;
remotely obtaining data from the privacy token; and
authorizing the action if the data from the privacy token verifies that the requester is authorized to take the action.

2. A method, according to claim 1, wherein the action includes issuing a credit card for the requester.

3. A method, according to claim 1, wherein the privacy token is a smart card.

4. A method, according to claim 1, wherein the data is digitally signed.

5. A method, according to claim 1, further comprising:
authorizing the action if the requester had previously indicated a desire not to require presentation of the privacy token.

6. A method, according to claim 1, wherein the action is authorized only if the data from the privacy token verifies that the requester is authorized to take the action.

7. A method, according to claim 1, wherein the data provided in the privacy token is encrypted to inhibit directly ascertaining identifying information about the requester.

8. A method, according to claim 7, wherein the data is encrypted using a one-way hash function.

9. A method, according to claim 8, further comprising:
applying the one-way hash function to identifying information about the requester and comparing the result thereof with the data provided in the privacy token.

10. A method, according to claim 1, wherein the requester provides the privacy token in response to obtaining a particular credit score for the requester.

11. A computer readable medium having computer executable instructions for performing the steps recited in claim 1.

12. A privacy token, comprising:
an electronic identifier that stores data;
a data communicator coupled to the electronic identifier; and
data, provided on the electronic identifier, that binds the privacy token to a holder thereof, wherein the data is authenticated by an authority that is trusted by a provider of service to the holder.

13. A privacy token, according to claim 12, wherein the data is digitally signed by the authority.

14. A privacy token, according to claim 12, wherein the data provided in the privacy token is encrypted using a one-way hash function to inhibit directly ascertaining identifying information about the requester.

15. A method of administering privacy tokens that have data that binds each of the privacy tokens to a holder thereof using authenticated data, the method comprising:
receiving, from a token issuing authority, authenticated information indicating that a particular privacy token has been issued; and
providing a transaction authority with authenticated information indicating that the particular privacy token has been issued by the token issuing authority, wherein the transaction authority authorizes use of the privacy token in response to receiving the second authenticated information.

16. A method, according to claim 15, wherein the authenticated information received from the token issuing authority is different from the authenticated information provided to the transaction authority.

17. A method, according to claim 15, wherein the authenticated information received from the token issuing authority is the same as the authenticated information provided to the transaction authority.

18. A method, according to claim 15, wherein an authority granting agency communicates information indicating particular token issuing privileges of the token issuing authority.

19. A method, according to claim 18, wherein the authenticated information provided to the transaction authority depends, at least in part, on information provided by the authority granting agency.

20. A computer readable medium having computer executable instructions for performing the steps recited in claim 15.
